(19) United States
(12) Patent Application Publication
(10) Pub. No.: US 2014/0294249 A1
(43) Pub. Date: Oct. 2, 2014

(54) FRAME CONTROLLING METHOD AND ELECTRIC DEVICE USING THE SAME

(71) Applicant: WISTRON CORPORATION, New Taipei City (TW)

(72) Inventors: Chun-Tung Cheng, New Taipei City (TW); Shi-Rui Lee, New Taipei City (TW)

(73) Assignee: Wistron Corporation, New Taipei City (TW)

(21) Appl. No.: 13/873,283

(22) Filed: Apr. 30, 2013

(30) Foreign Application Priority Data
Mar. 29, 2013 (TW) 102111511

(51) Int. Cl. G06K 9/00

(52) U.S. Cl. CPC G06K 9/00885
USPC 382/115

(57) ABSTRACT

A frame controlling method and an electric device using the same are provided. The frame controlling method includes the following steps. An image including a first person is captured by a front camera disposed on a screen. If a second person is shown in the image, then an identification of the second person is recognized. A frame setting data is read according to the identification of the second person. A frame of the screen is changed according to the frame setting data.

This application claims the benefit of Taiwan application Serial No. 102111511, filed Mar. 29, 2013, the subject matter of which is incorporated herein by reference.

### BACKGROUND

1. Technical Field

The disclosure relates in general to a frame controlling method and an electronic device using the same, and more particularly to a frame controlling method adapting a human recognition technology and an electronic device using the same.

2. Description of the Related Art

Accompanying advancements in technologies, various information apparatus are constantly progressing. People usually use those information apparatuses in varied places. Others can easily see the display content while the information apparatus is being used by a user.

For preventing some confidential data from disclosing, the user must turn off the window or turn off the information apparatus in haste. In most situations, the user cannot successfully prevent the display content from seeing by others; therefore, the information security cannot be ensured. Therefore, how to successfully ensure the information security is one of important targets in research.

### SUMMARY

The disclosure is directed to a method of a frame controlling method and an electronic device using the same. Frame is changed by adapting a human recognition technology to ensure the information security.

According to a first aspect according to the present disclosure, a frame controlling method of an electronic device is provided. A frame controlling method of an electronic device comprises the following steps. An image including a first person is captured by a front camera disposed on a screen. An identification of a second person is recognized, if a second person is shown in the image. A frame setting data is read according to the identification of the second person. A frame of the screen is changed according to the frame setting data.

According to a second aspect according to the present disclosure, an electronic device is provided. The electronic device includes a screen, a front camera, an image recognizing unit, a database, and a processing unit. The screen is for displaying a frame. The front camera is for capturing an image including a first person. The image recognizing unit is for recognizing an identification of a second person if the second person is shown in the image. The database is for storing a frame setting data. The processing unit is for reading the frame setting data according to the identification of the second person and controlling the screen to change the frame according to the frame setting data.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows an electronic device.

FIG. 2 shows a flow chart of a frame controlling method of the electronic device.

FIGS. 3A to 3B show a step of switching a login identification of the electronic device.

FIGS. 4A to 4B show a step of hiding whole of a window of an application program.

FIGS. 5A to 5B show a step of hiding a field of an application program.

FIGS. 6A to 6G show a setup menu of a frame setting data.

### DETAILED DESCRIPTION

Preferred embodiments are disclosed below for elaborating the invention. Frame is changed by adapting a human recognition technology to ensure the information security. The following embodiments are for the purpose of elaboration only, not for limiting the scope of protection of the invention. Besides, secondary elements are omitted in the following embodiments to highlight the technical features of the invention.

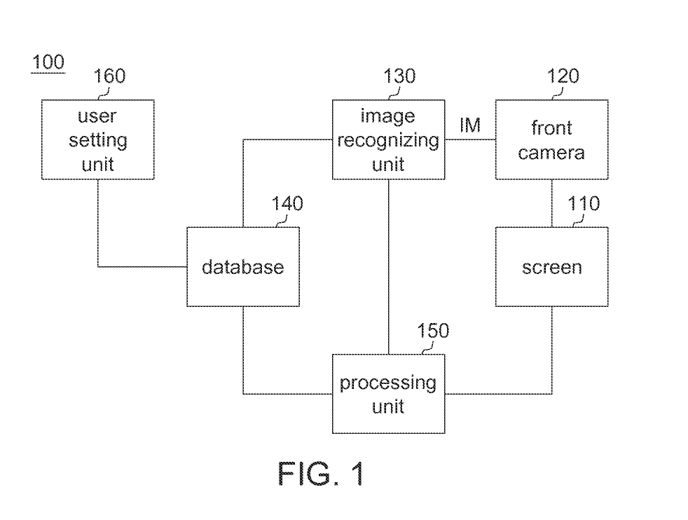

Please referring to FIG. 1, an electronic device 100 is shown. For example, the electronic device 100 can be a notebook computer, a smart phone or a tablet computer. The electronic device 100 includes a screen 110, a front camera 120, an image recognizing unit 130, a database 140, a processing unit 150 and a user setting unit 160.

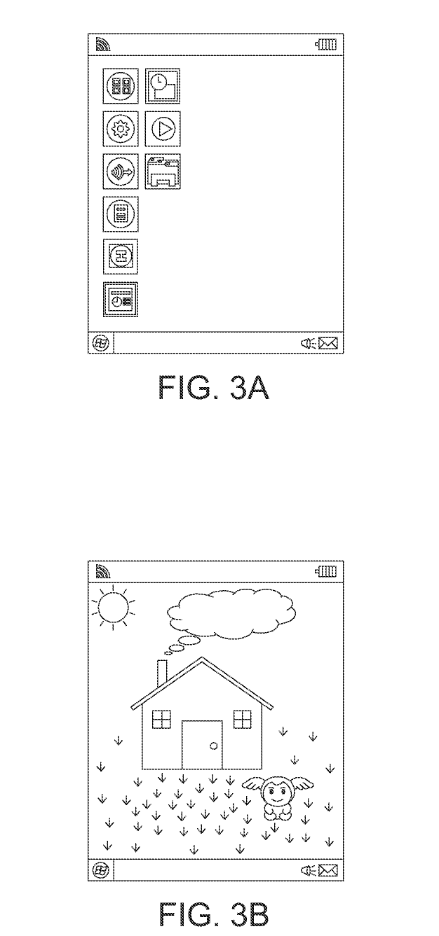

The screen 110 is used for displaying a frame, such as a frame shown in FIG. 3A. For example, the screen 110 can be a liquid crystal display (LCD), a cathode ray tube (CRT) display or an organic light-emitting diode (OLED) display.

The front camera 120 is for capturing an image IM. The front camera 120 and the frame are located at the same side of the screen 110. The front camera 120 can capture the person who is watching the frame.

The image recognizing unit 130 is for performing an image recognizing process by varied recognizing technology. For example, the image recognizing unit 130 can be an image recognizing chip, an image recognizing firmware circuit or a storage medium storing a plurality of program codes.

The database 140 is for storing varied data. For example, the database 140 can be a hard disk, a memory, a memory card or an optical disk.

The processing unit 150 is for performing varied processing process. The processing unit 150 can be a processing chip, a processing firmware circuit or a storage medium storing a plurality of program codes.

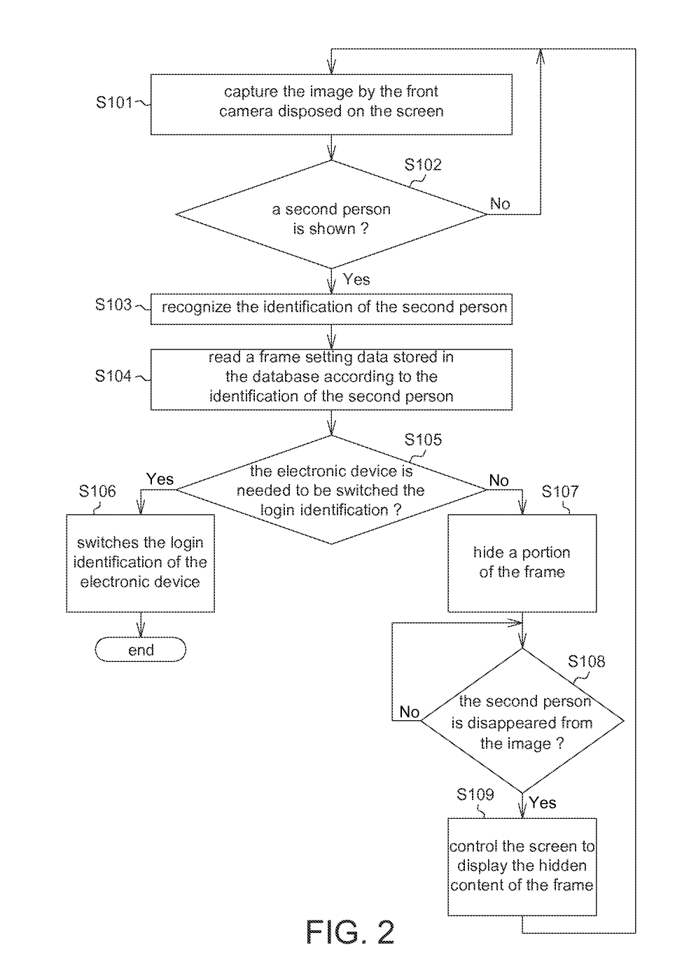

The electronic device 100 described above can immediately change the frame by the human recognition technology to ensure the information security. Please referring to FIG. 2, a flowchart of a frame controlling method of the electronic device 100 is shown. The operations of the elements described above are illustrated in detail by the flowchart. However, the steps of FIG. 2 are not limited to the electronic device 100 of FIG. 1. The electronic device 100 of FIG. 1 is not limited to the steps of FIG. 2 too.

In the step S101, the image IM is captured by the front camera 120 disposed on the screen 110. The image IM includes a first person, such as the user using the electronic device 100 in front of the screen 110.

In the step S102, the processing unit 150 determines whether a second person is shown in the image IM. If the second person is shown in the image IM, then the process proceeds to the S103; if the second person is not shown in the image IM, then the process backs to the step S101.

In the step S103, the identification of the second person is recognized by the image recognizing unit 130. The database 140 stores a plurality of human pictures and identifications corresponding thereto in advance. The image recognizing unit 130 compares the second person with the human pictures to recognize the identification of the second person. If the identification of the second person cannot be recognized from the human pictures of the database 140, then the identification of the second person is defined as “undefined person.”

In the step S104, a frame setting data stored in the database 140 is read according to the identification of the second person. The frame setting data is preset by the user. The identification of the second person corresponds to a particular frame setting data. Each frame setting data records a frame controlling procedure. The frame controlling procedure can be a step of switching a login identification of the electronic device 100 to change the frame, or a step of hiding a portion of the frame to change the frame.

In the steps S105 to S107, the processing unit 150 changes the frame of the screen 110 according to the frame setting data. Firstly, in the step S105, the processing unit 150 determines whether the electronic device 100 is needed to be switched the login identification thereof according to the frame setting data. If the electronic device 100 is needed to be switched the login identification thereof, then the process proceeds to the step S106; if the electronic device 100 is not needed to be switched the login identification thereof, then the process proceeds to the step S107.

In the step S106, the processing unit 150 switches the login identification of the electronic device 100 to change the frame. For example, please referring to FIGS. 3A to 3B, the step of switching the login identification of the electronic device 100 is shown. The processing unit 150 logouts the present login identification of the electronic device 100 automatically, then the processing unit 150 logins another login identification of the electronic device 100 according to the frame setting data.

The login and logout process can be performed without showing on the screen by the processing unit 150. The frame of the FIG. 3A is directly changed to the frame of the FIG. 3B on the screen without showing any login/logout frame. When the second person approaches to the electronic device 100, he would not notice the login/logout process. He will see the changed frame of the FIG. 3B, but he will not see the original frame of FIG. 3A. As such, the frame of FIG. 3A will not be seen by the second person who suddenly approaches.

Moreover, because another login identification logins the electronic device 100, the use of the application programs and the data of the electronic device 100 is limited to this login identification. Even if the electronic device 100 is controlled by the second person, the information security of the first person can be protected.

Generally speaking, if the image IM belongs “undefined person”, switching the login identification is a suitable procedure. In addition, the corresponding login identification of the second person can be recorded in the frame setting data.

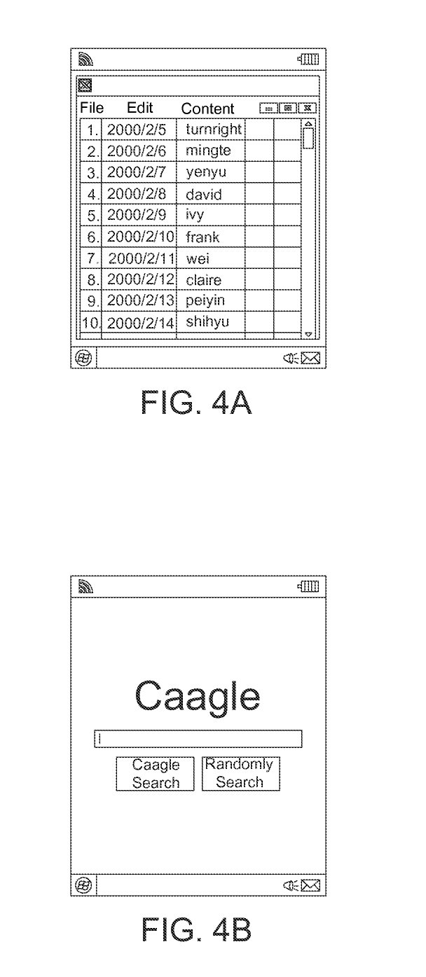

In the step S107, the processing unit 150 hides a portion of the frame to change the frame. For example, please referring to FIGS. 4A to 4B, the step of hiding whole of a window of an application program is shown.

The processing unit 150 automatically hides whole of a window of an application program of FIG. 4A and switches to a window of another application program. As such, the content of the application program of FIG. 4A will not seen by the second person who suddenly approaches.

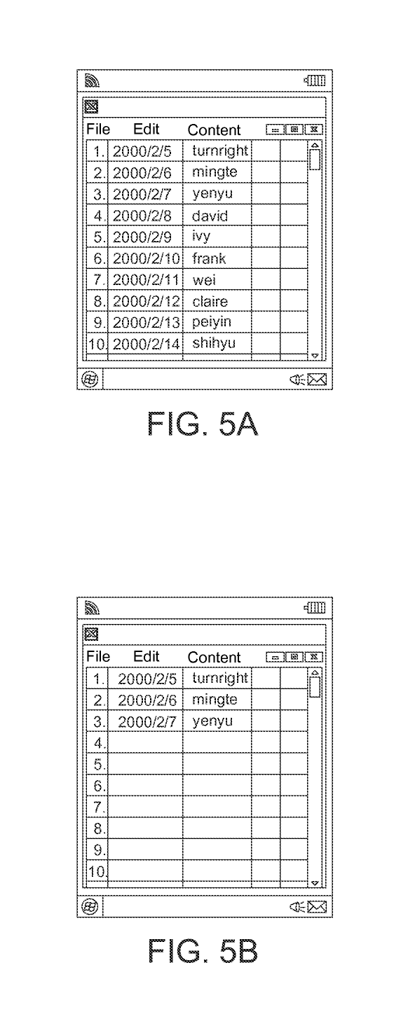

For another example, please referring FIGS. 5A to 5B, the step of hiding a field data of an application program is shown. The processing unit 150 can automatically hides a field of an application program to change the frame. As such, the important data in this field will not seen by the second person who suddenly approaches.

In step S108, the processing unit 150 determines whether the second person is disappeared from the image IM. If the second person is disappeared from the image IM, then the process proceeds to the step S109; if the second person is not disappeared from the image IM, then the process backs to the step S108.

In the step S109, the processing unit 150 controls the screen 110 to display the hidden content of the frame. That is to say, after the second person leaves, the frame can be returned to the original status for the first person.

In the frame controlling method and the electronic device 100 using the same, the frame is changed by adapting the human recognition technology to ensure the information security and prevent some confidential data from disclosing.

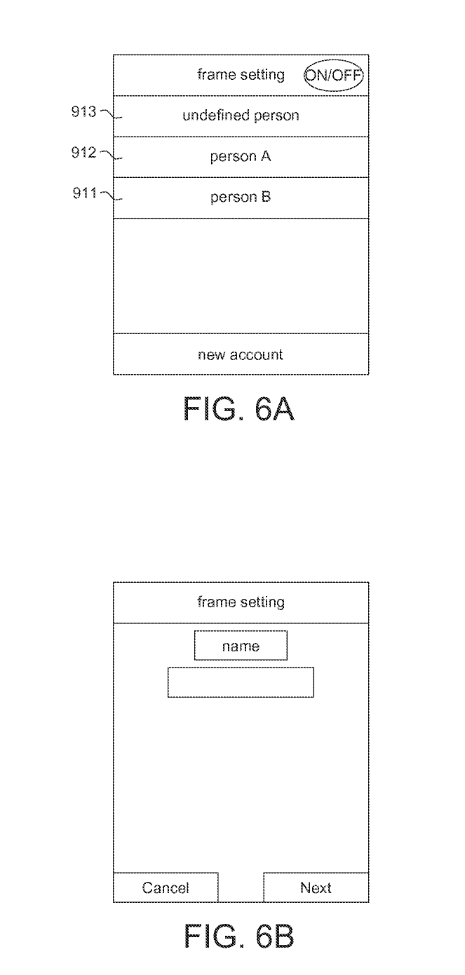

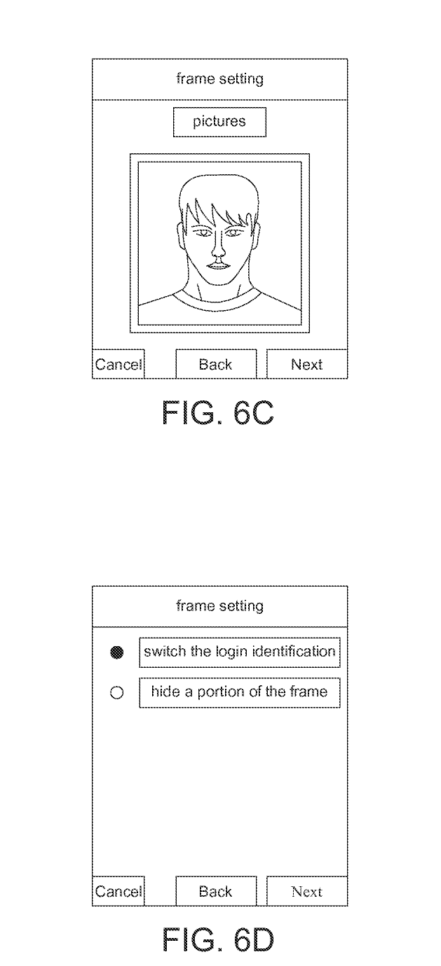

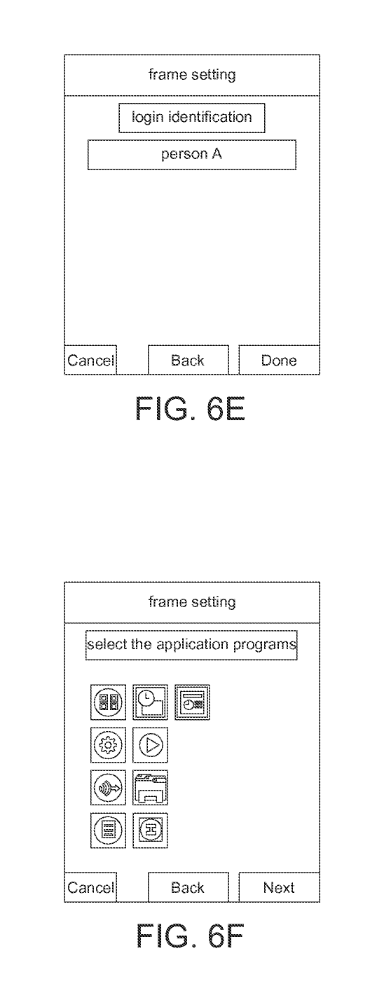

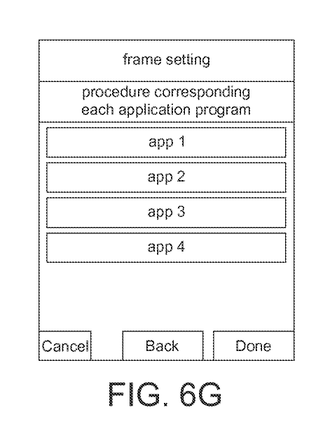

Please referring to FIGS. 6A to 6G, a setup menu of the frame setting data is shown. The frame setting data described above can be preset via the user setting unit 160. The operation of the user setting unit 160 is illustrated via several drawings. As shown in FIG. 6A, the switching button 910 located at the upper right corner is used for determining whether the frame controlling method is enable. The user can create a plurality of accounts 911, 912 and 913. The accounts 911, 912 can be a defined person A and a defined person B respectively. The account 913 can be an undefined person. If the second person cannot be recognized, then the second person is classified as the account 913. The user can select one of the accounts 911, 912 and 913 in FIG. 6A for setting the content thereof.

As shown in FIG. 6B, when the user selects one of the accounts 911, 912 and 913, the name thereof can be defined here.

As shown in FIG. 6C, a picture of the selected account is stored. If the user selects the account 913, i.e. the undefined person, then this step is skipped.

As shown in FIG. 6D, the frame controlling procedure is defined to be the step of switching the login identification or hiding a portion of the frame. If the frame controlling procedure is defined to be the step of switching the login identification, then the setup menu turns into FIG. 6E; if the frame controlling procedure is defined to be the step of hiding the portion of the frame, then the setup menu turns into FIGS. 6F to 6G.

As shown in FIG. 6E, the user can select the login identification. The electronic device 100 can store a plurality of login identifications for being selected by the user. The user can select a login identification which corresponds to the picture of the account or another login identification which does not correspond to the picture of the account.

On the other hand, as shown in FIG. 6F, the user can select several application programs which are relate to the information security.

As shown in FIG. 6G, the user can setup the detail items of each selected application program. For example, as shown in FIG. 6G, whole of a window of one selected application program can be hidden, or a field of one selected application program can be hidden.

The frame setting data and whether the frame controlling method is enable can be preset via the setup menu of the frame setting data.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A frame controlling method of an electronic device, comprising:
capturing an image including a first person by a front camera disposed on a screen;
recognizing an identification of a second person, if a second person is shown in the image;
reading a frame setting data according to the identification of the second person; and
changing a frame of the screen according to the frame setting data.

2. The frame controlling method according to claim 1, wherein the step of changing the frame of the screen includes:
switching a login identification of the electronic device to change the frame.

3. The frame controlling method according to claim 1, wherein the step of changing the frame of the screen includes:
hiding a portion of the frame to change the frame.

4. The frame controlling method according to claim 3, wherein in the step of hiding a portion of the frame, whole of a window of an application program is hidden to change the frame.

5. The frame controlling method according to claim 3, wherein in the step of hiding a portion of the frame, a field of an application program is hidden to change the frame.

6. The frame controlling method according to claim 3, further comprising:
displaying the hidden portion of the frame, if the second person is disappeared from the image.

7. An electronic device, comprising:
a screen, for displaying a frame;
a front camera, for capturing an image including a first person;
an image recognizing unit, for recognizing an identification of a second person if the second person is shown in the image;
a database, for storing a frame setting data; and
a processing unit, for reading the frame setting data according to the identification of the second person and controlling the screen to change the frame according to the frame setting data.

8. The electronic device according to claim 7, wherein the processing unit switches a login identification of the electronic device to change the frame.

9. The electronic device according to claim 7, wherein the processing unit hides a portion of the frame to change the frame.

10. The electronic device according to claim 9, wherein the processing unit hides whole of a window of an application program to change the frame.

11. The electronic device according to claim 9, wherein the processing unit hides a field of an application program to change the frame.

12. The electronic device according to claim 9, wherein the processing unit controls the screen to display the hidden portion of the frame, if the second person is disappeared from the image.
